(19) United States
(12) Patent Application Publication
(10) Pub. No.: US 2009/0249132 A1
(43) Pub. Date: Oct. 1, 2009

(54) Data Processing Apparatus and Method of Verifying Programs

(75) Inventor: Ryuji Sakai, Hanno-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Kabushiki Kaisha Toshiba, Tokyo (JP)

(21) Appl. No.: 12/397,127

(22) Filed: Mar. 3, 2009

(30) Foreign Application Priority Data
Mar. 28, 2008 (JP) 2008-086933

(51) Int. Cl. G06F 11/08; G06F 9/46

(52) U.S. Cl. 714/49; 718/106; 714/E11.03

(57) ABSTRACT

According to one embodiment, an information processing apparatus includes a plurality of execution modules, a system memory shared by the plurality or execution modules, and a scheduler which controls assignment of a plurality of basic modules to the plurality of execution modules in order to execute a program in parallel by the plurality of execution modules. The scheduler saves data items, which is to be input by the execution modules as input data items of the basic modules and is stored in the storage areas of the system memory, in other storage areas of the system memory before the basic modules are executed, and compares the data items stored in the storage areas of the system memory and accessed by the execution modules with the data items saved in the other storage areas of the system memory after the basic modules have been executed.

### CROSS-REFERENCE TO RELATED APPLICATIONS

This application is based upon and claims the benefit of priority from Japanese Patent Application No. 2008-086933, filed Mar. 28, 2008, the entire contents of which are incorporated herein by reference.

### BACKGROUND

1. Field

One embodiment of the invention relates to a technique of verifying programs for, e.g., a computer that mounts a CPU including a plurality of CPU cores or a computer that mounts a plurality of CPUs.

2. Description of the Related Art

In recent years, various types of computers (personal computers) for private use, such as notebook type computers and desktop type computers are widely used. For such computers, demands for information processing capability have been increasing to close to the limits of CPU performance improvement. For example, there is a demand for playing back high resolution moving image data by software.

In view of this, for example, computers which mount a plurality of CPUs, and recently, a CPU including a plurality of CPU cores, have become available. These computers shorten the turnaround time and improve the performance by processing programs in parallel. Various mechanisms for efficiently executing programs in parallel have been proposed (see, e.g., Jpn. Pat. Appln. KOKAI Publication No. 2005-258920).

One parallel processing technique of a program comprises two components, i.e., runtime processing including a scheduler, which assigns processing units in the program to execution units (when a computer mounts a plurality of CPUs, the scheduler assigns the processing units to the CPUs, and when a computer mounts a CPU including a plurality of CPU cores, the scheduler assigns the processing units to the CPU cores), and a processing unit processed on each execution unit.

To accomplish parallel processing of a program, the processing units must keep independent of one another. Assume that the output data of a processing unit “A” is input to processing units “B” and “C”. In this case, the outputs of processing units “B” and “C” should results from only the output data of processing unit “A”. Therefore, the storage areas of the memory that hold the input data of every processing unit must be managed as a read-only area, i.e., un-rewritable area in which no data can be rewritten. If processing unit “B”, which starts before processing unit “C” does, overwrites the input data, it will influence the output of processing unit “C”.

To prevent such an event, or to verify the authenticity of the program, the program is tested by using the test code embedded in itself. The test requires a higher cost than programming. Moreover, in the parallel processing of a program, the reproducibility of program errors is so low that debugging can hardly be achieved.

In order to process any program in parallel, the processing units constituting the program must be verified to have a re-entrant property in consideration of the case where same basic module may be simultaneously read from a plurality of execution unit. This verification also has the same problem as described above.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view showing a system configuration of an information processing apparatus according to an embodiment of the invention;

FIG. 2 is an exemplary view for explaining the schematic configuration of a program based on parallel processing specifications, which is executed by the information processing apparatus according to the embodiment;

FIG. 3 is an exemplary view showing general multi thread processing;

FIG. 4 is an exemplary view showing the relationship between basic serial modules and a parallel execution control description which are included in the program executed by the information processing apparatus according to the embodiment;

FIG. 5 is an exemplary view for explaining the parallel execution control description of the program executed by the information processing apparatus according to the embodiment;

FIG. 6 is an exemplary view for explaining the parallel processing control of the program executed by a runtime library operating on the information processing apparatus according to the embodiment;

FIG. 7 is an exemplary view showing the operation state of the runtime libraries on the information processing apparatus according to the embodiment;

FIG. 8 is an exemplary functional block diagram of the runtime library operating on the information processing apparatus according to the embodiment;

FIG. 9 is an exemplary diagram showing a memory model that works when the parallel program operates;

FIG. 10 is an exemplary view for explaining the first operation of verifying the parallel processing executed by the runtime library operating on the information processing apparatus according to the embodiment;

FIG. 11 is an exemplary view for explaining the second operation of verifying the parallel processing executed by a runtime library operating on the information processing apparatus according to the embodiment;

FIG. 12 is an exemplary view for explaining the case where the first and second operations of verifying the parallel processing is executed, in parallel, by the runtime library operating on the information processing apparatus according to the embodiment;

FIG. 13 is an exemplary flowchart showing the operation sequence of the first operation of verifying the parallel processing executed by the runtime library operating on the data processing apparatus according to the embodiment;

FIG. 14 is an exemplary flowchart showing the operation sequence of the second operation of verifying the parallel processing executed by the runtime library operating on the data processing apparatus according to the embodiment;

FIG. 15 is a first view for explaining a modified operation of verifying the parallel processing executed by the runtime library operating on the data processing apparatus according to the embodiment; and

FIG. 16 is a second view for explaining another modified operation of verifying the parallel processing executed by the runtime library operating on the data processing apparatus according to the embodiment.

### DETAILED DESCRIPTION

Various embodiments according to the invention will be described hereinafter with reference to the accompanying drawings. In general, according to one embodiment of the invention, an information processing apparatus includes a plurality of execution modules, a system memory shared by the plurality of execution modules, and a scheduler which controls assignment of a plurality of basic modules to the plurality of execution modules in order to execute a program in parallel by the plurality of execution modules. The scheduler saves data items, which is to be input by the execution modules as input data items of the basic modules and is stored in the storage areas of the system memory, in other storage areas of the system memory before the basic modules are executed, and compares the data items stored in the storage areas of the system memory and accessed by the execution modules with the data items saved in the other storage areas of the system memory after the basic modules have been executed.

FIG. 1 is an exemplary view showing a system configuration of an information processing apparatus according to the embodiment. The information processing apparatus is implemented as a so-called personal computer such as a notebook type computer or desktop type computer. As shown in FIG. 1, this computer includes a processor 1, main memory 2, and hard disk drive (HDD) 3, which are interconnected via an internal bus.

The processor 1 serves as a central processing unit (CPU) which controls the execution of a program loaded in the main memory 2 from the HDD 3, and includes a plurality of cores 11 serving as main arithmetic circuits (CPU cores).

The main memory 2 is, e.g., a semiconductor storage device, and can be accessed by the processor 1.

The HDD 3 is a low-speed mass storage device (in comparison with the main memory 2) serving as an auxiliary storage in the computer.

Although not shown in FIG. 1, input/output devices such as a display for displaying the processing result of the program executed by the processor 1 and the like, and a keyboard for inputting process data and the like are provided for, e.g., a notebook type computer, or are externally connected via cables for, e.g., a desktop type computer.

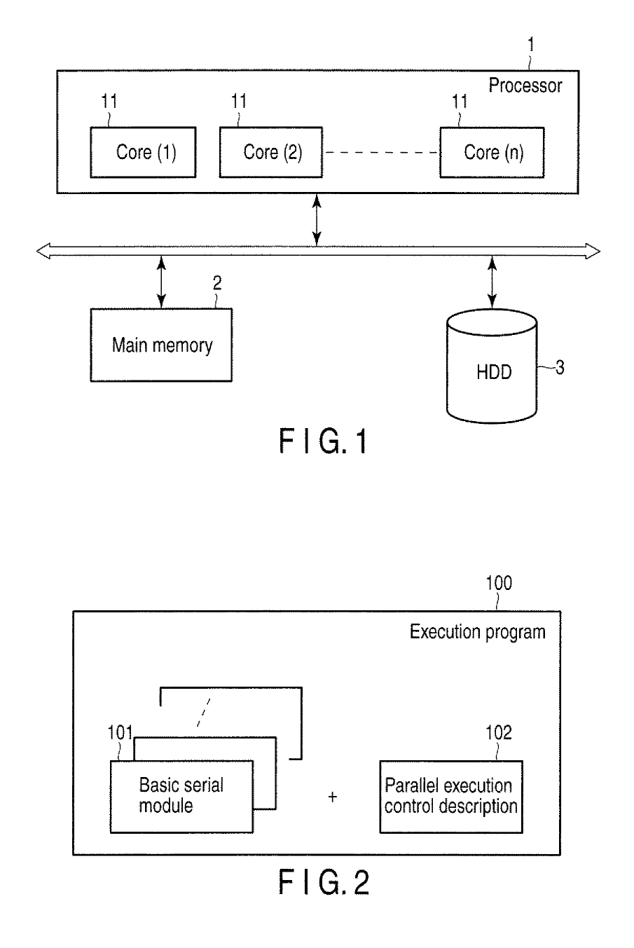

The computer which mounts the processor 1 including the plurality of cores 11 can execute a plurality of programs in parallel, and also execute a plurality of processes in one program in parallel. The schematic configuration of a program, based on parallel processing specifications, which is executed by the computer will be described with reference to FIG. 2.

As shown in FIG. 2, an execution program 100 based on parallel processing specifications, which is executed by the computer includes a plurality of basic serial modules 101, and a parallel execution control description 102 which defines an order of executing the plurality of basic serial modules 101.

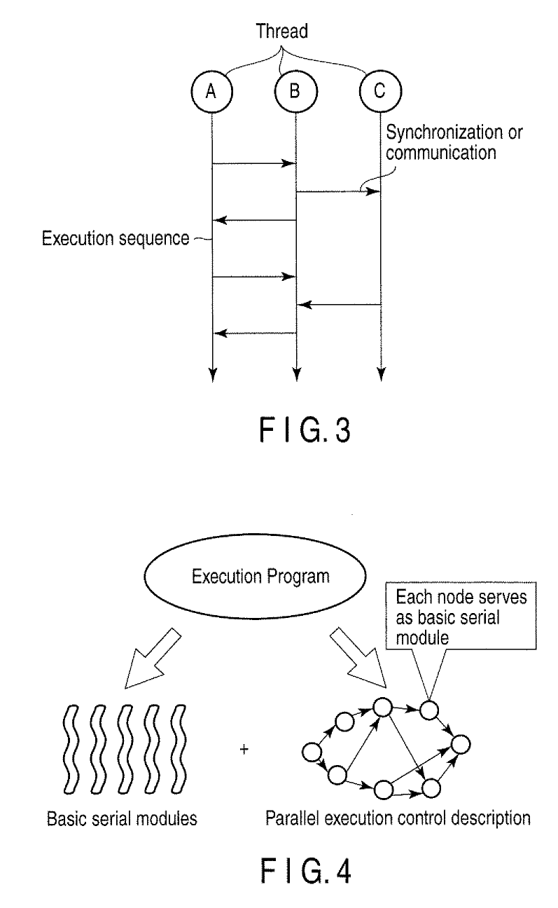

In so-called multi-thread processing, as shown in FIG. 3, each thread progresses while synchronizing with other threads (including communication), i.e., maintaining consistency of the program as a whole. If the frequency of waiting for synchronization is high, it may be impossible to obtain the parallel performance expected.

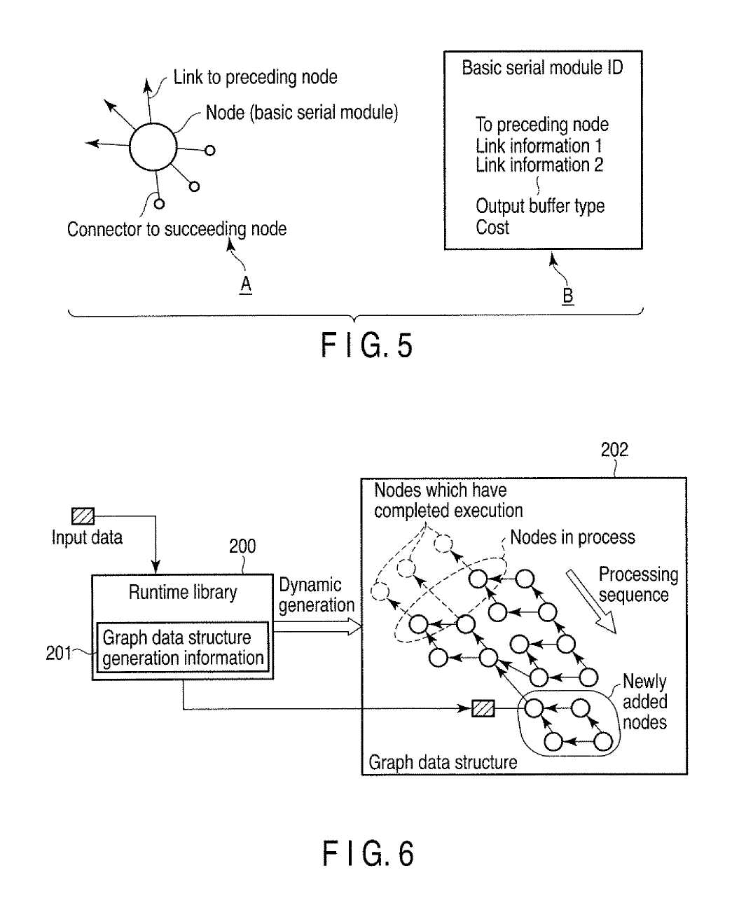

Therefore, in this embodiment, as shown in FIG. 4, by dividing a program into processing units which need not synchronize with other modules and thus can be asynchronously executed, a plurality of basic serial modules 101 are created while a parallel execution control description 102 which defines a paralleled execution description for the plurality of basic serial modules 101 is created. Under the parallel execution control, each of the basic serial modules 101 is represented as a node. As explained above, a basic serial module indicates a module as a processing unit which can be executed asynchronously with other modules. The parallel execution control description 102 will be described next with reference to FIG. 5.

“A” in FIG. 5 denotes a schematic node representing one of the basic serial modules 101. As shown in FIG. 5, each of the basic serial modules 101 can be considered as a node having links to preceding nodes and connectors to succeeding nodes. The parallel execution control description 102 defines an order of executing the plurality of basic serial modules 101 by describing link information on preceding nodes with respect to each of the basic serial modules 101. “B” in FIG. 5 denotes a parallel execution control description associated with one of the basic serial modules 101. As shown in FIG. 5, the description describes a basic serial module ID serving as the identifier of the basic serial module 101, and link information on the preceding nodes of the basic serial module 101. Also, the description describes information on an output buffer type, cost, and the like.

A method by which the computer executes the execution program 100 having a unique configuration in that a plurality of basic serial modules 101 and a parallel execution control description 102 are included will now be described.

To execute, in parallel, the execution program 100 having such unique configuration, a runtime library 200 shown in FIG. 6 is prepared in the computer. The runtime library 200 has a scheduler function, and is provided with the parallel execution control description 102 as graph data structure generation information 201. The parallel execution control description 102 is created by, e.g., using a functional programming language, and translated into the graph data structure generation information 201 by a translator.

When data is input, there is a need for executing some of the basic serial modules 101 for processing the data. Each time the need arises, the runtime library 200 dynamically generates/updates a graph data structure 202 on the basis of the graph data structure generation information 201. The graph data structure 202 is graph data representing the relationship between preceding and succeeding nodes to be executed as needed. The runtime library 200 adds the nodes to the graph data structure 202 in consideration of the relationship between preceding and succeeding nodes in an execution waiting state as well as the relationship between the preceding and succeeding nodes to be added.

Upon completion of the execution of a node, the runtime library 200 deletes the node from the graph data structure 202, and checks the presence/absence of a succeeding node which designates the node as a preceding node and which does not have other preceding nodes or of which all other preceding nodes have been completed. If there exists a succeeding node which satisfies the condition, the runtime library 200 assigns the node to one of the cores 11.

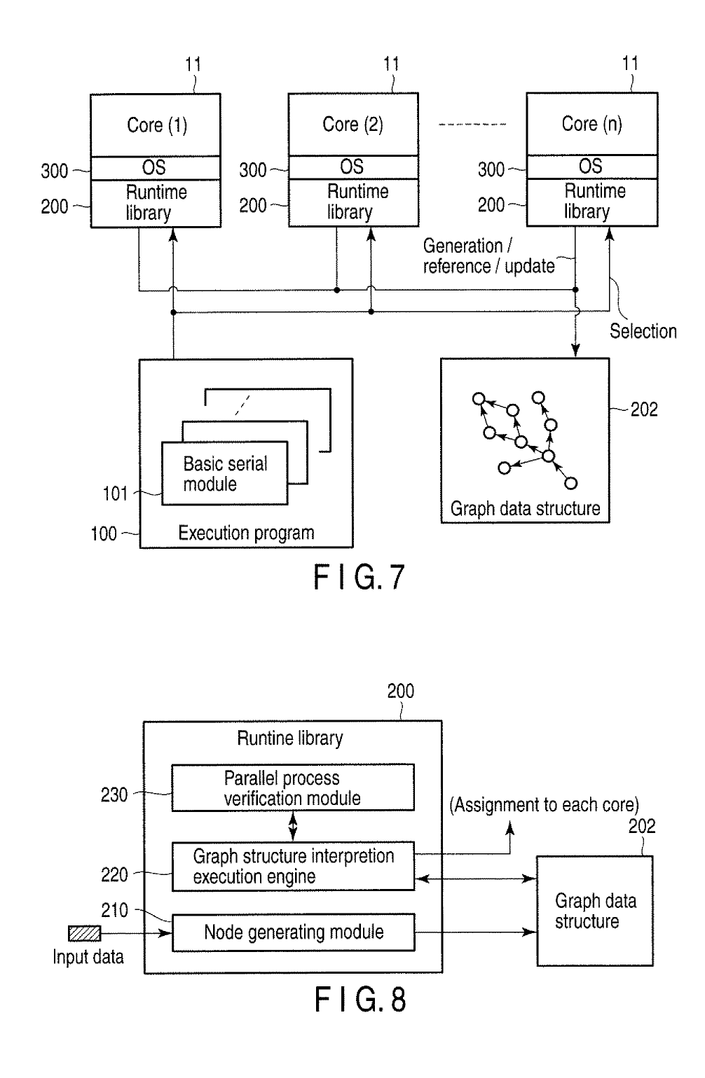

With this operation of the runtime library 200, the parallel execution of the plurality of basic serial modules 101 progresses on the basis of the parallel execution control description 102 without contradiction. After the basic serial modules 101 have been executed, the runtime library 200 is exclusively called for checking the input/output data, updating the graph data and selecting a basic serial module 101 that should be executed next. Then, the runtime library 200 returns. The core 11 executes the basic serial module 101 selected by runtime library 200. The other cores 11 call, one after another, the runtime library 200 to acquire the basic serial module 101 and execute the acquired one. The exclusive control of each thread is limited only when the runtime library 200 selects a node from the graph data structure 202 or only when the graph data structure 202 is updated (see FIG. 7). Therefore, the basic serial modules 101 can be executed in parallel, more efficiently than is possible in the ordinary multi-thread process as shown in FIG. 3.

As indicated above, the program is split into such segments as can be executed asynchronously, thus providing a plurality of basic serial modules 101, and the runtime library 200 allocates the basic serial modules 101 to a plurality of cores 11, respectively. Hence, in the computer provides a mechanism that detects the problem that each basic serial module 101 overwrites the input data when the program is executed, without rewriting the source code of the input data. The computer further provides a mechanism that determines whether the basic serial modules 101 have a re-entrant property so that they may be simultaneously called. The mechanisms will be described below, in detail.

FIG. 8 is an exemplary functional block diagram of the runtime library 200.

As shown in FIG. 8, the runtime library 200 includes a node generating module 210, a graph structure interpretion execution engine 220 and a parallel process verification module 230.

The node generating module 210 and graph structure interpretion execution engine 220 cooperate to dynamically generate and update a graph data structure 202 based on the graph data structure generation information 201, and to allocate the basic serial modules 101 to a plurality of cores 11 in accordance with the graph data structure 202. The parallel process verification module 230 verifies the parallel processing implemented by the node generating module 210 and graph structure interpretion execution engine 220.

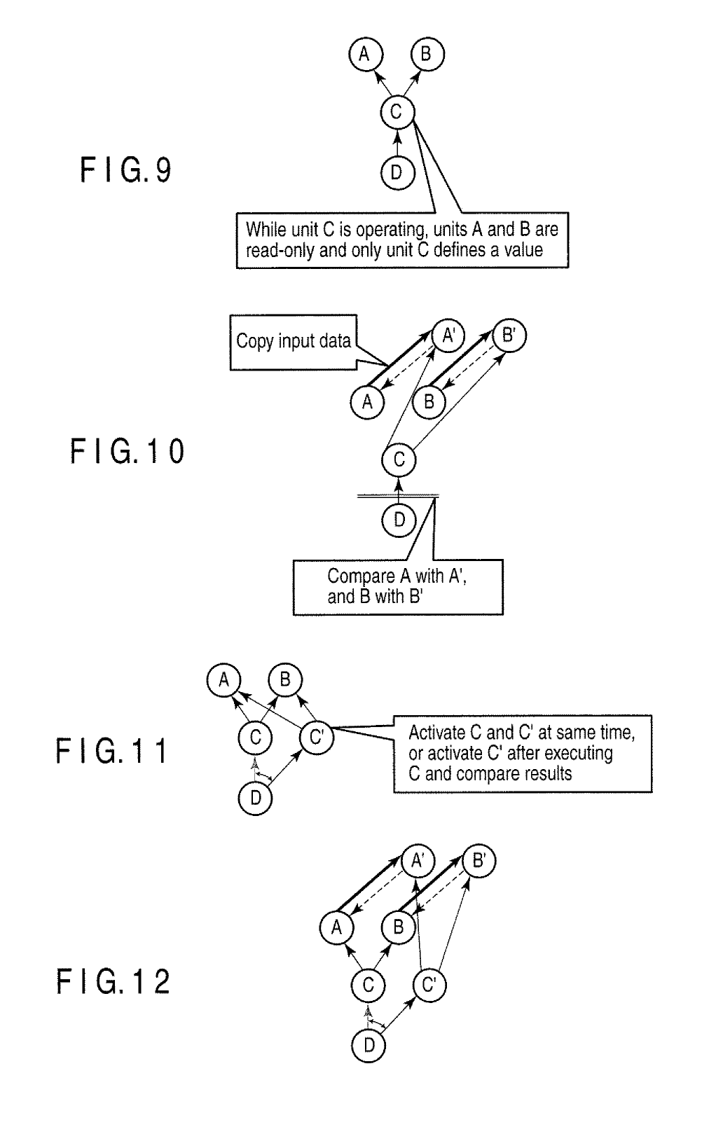

FIG. 9 shows the memory model that works when the parallel program operates. To accomplish parallel processing a program, the processes undergone in parallel must keep independent of one another. In any graph-based parallel processing, the result of executing a preceding node, which is the input data, is managed as read-only data and is stored in an un-rewritable area. The area in which to write a value in each basic serial module 101 is only an output buffer from which the result of executing the preceding node will be output. Thus, the result of executing each basic serial module 101 is determined by the input data only, not interfering with the operation of the other basic serial modules 101.

Such restriction, if is imposed, cannot be checked by a compiler when the basic serial modules 101 are described in C or C++ in order to achieve some performance. Further, although a data items can be allocated to the read-only sections, by a program loader, in accordance with different of allocating address spaces, basic serial module 101 of preceding nodes writes the result of executing and, thus, the result of executing each basic serial module 101 cannot be fully protected by means of simple hardware.

This is why the parallel process verification module 230 of the runtime library 200 determines whether the input data has changed or not while the basic serial module 101 is being executed. More specifically, as shown in FIG. 10, before each basic serial module 101 is executed, the result of executing the preceding node (i.e., input) is saved in a work memory. After the basic serial module 101 has been executed, the data saved is compared with the input data, thereby determining whether the input data has changes or not. Check code showing the result of this comparison need not be embedded in the source code every time the parallel program is installed, because the runtime library 200 can be applied to all parallel programs. This can increase the efficiency of developing the parallel programs. In addition, this ensures the embedding of the test code in the program. Having embedded test code, the program can be very reliable.

The parallel process verification module 230 of the runtime library 200 not only monitors the change in the input data, but also determines whether the basic serial modules 101 have a re-entrant property (or thread safety). More precisely, as shown in FIG. 11, two buffers (which can be regarded as objects) are used, each for outputting the result of executing a node. Two basic serial modules 101 are then executed at the same time, thereby providing two results. The two results are compared. If the two results coincide with each other, one of them is discarded, and the process is continued. The verification can therefore proceed, not interrupted at all, as long as the processing units clear the text.

Whether the input data changes may be determined (see FIG. 10) at the same time whether the basic serial modules 101 have a re-entrant property (see FIG. 11) is determined. In this case, as shown in FIG. 12, before each basic serial module 101 is executed, the result of the preceding node (i.e., Input) is saved in the work memory, and the original input data and the data saved in the work memory are stored in the two buffers, respectively. Then, the basic serial module 101 that uses these data items as input is executed. After executing the basic serial module 101, the original input data is compared with the data saved in the work memory, thereby determining that the input data has not changed. In addition, whether the basic serial modules 101 have a re-entrant property is determined by comparing the two data items.

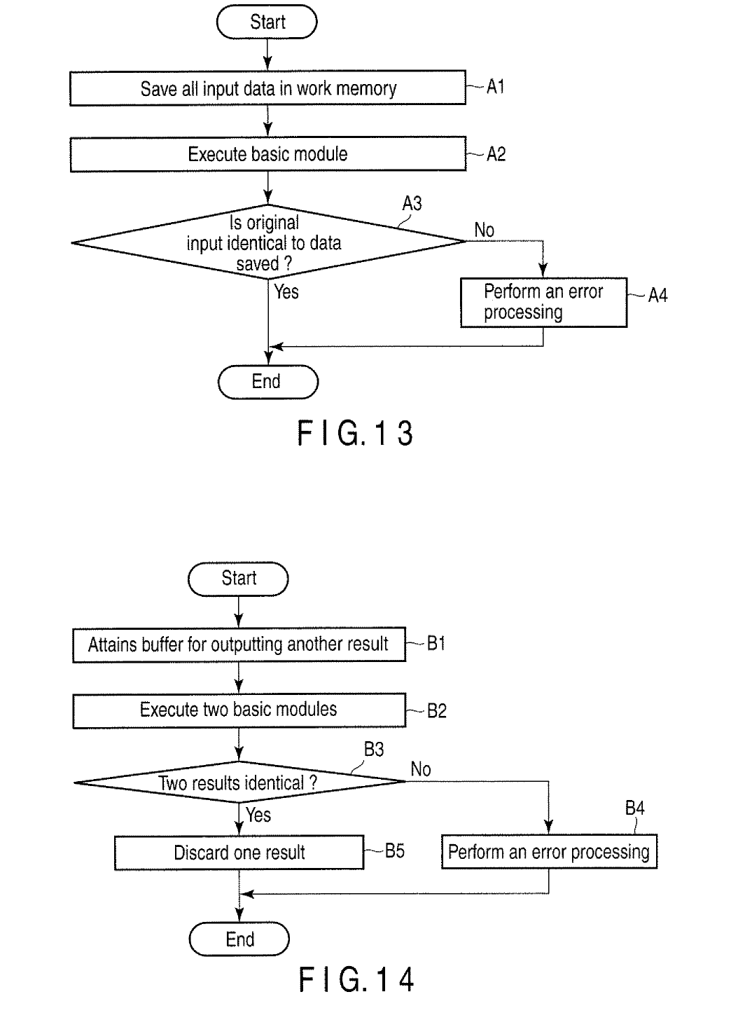

FIG. 13 is an exemplary flowchart showing the operation sequence of the first operation of verifying the parallel processing executed by the computer.

The parallel process verification module 230 of the runtime library 200 saves all input data items in the work memory before each basic serial module 101 is executed (Block A1).

After all input data items in the work memory have been so saved, the parallel process verification module 230 executes each basic serial module 101 (Block A2). Thereafter, the parallel process verification module 230 determines whether the original input coincides with the data saved in the work memory (Block A3). If the original input does not coincide with the data saved (NO in Block A3), the parallel process verification module 230 performs an error processing, for example, displaying a warning message and then terminating the execution of the program (Block A4).

FIG. 14 is an exemplary flowchart showing the operation sequence of the second operation of verifying the parallel processing executed by the computer.

Before the parallel process verification module 230 executes each basic serial module 101, it attains a buffer for outputting another result of executing another basic serial module 101 (Block B1). Then, the module 230 executes the basic serial module 101 and another basic serial module 101 (Block B2).

After executing the two basic serial modules 101, the parallel process verification module 230 determines whether the result of executing one module 101 coincides with the result of executing the other module 101 (Block 53). If the result of executing one module 101 does not coincide with that of executing the other module 101 (NO in Block B3), the parallel process verification module 230 performs an error processing, for example, displaying a warning message and then terminating the execution of the program (Block B4). If the result of executing one module 101 coincides with that of executing the other module 101 (YES in Block B3), the module 230 deallocates one of these results (Block B5). Then, the parallel process verification module 230 parallel process verification module 230 continues the execution of the program.

Thus, in the computer, the parallel process verification module 230 provided in the runtime library 200 verifies the parallel processing. This helps to reduce the cost of verifying any program that should be processed in parallel.

In the embodiment described above, parallel process verification module 230 examines each basic serial module 101 for overwriting of the input data and for a re-entrant property. Moreover, the parallel process verification module 230 may be configured to find, as early as possible, a timing problem that the parallel processing may potentially have.

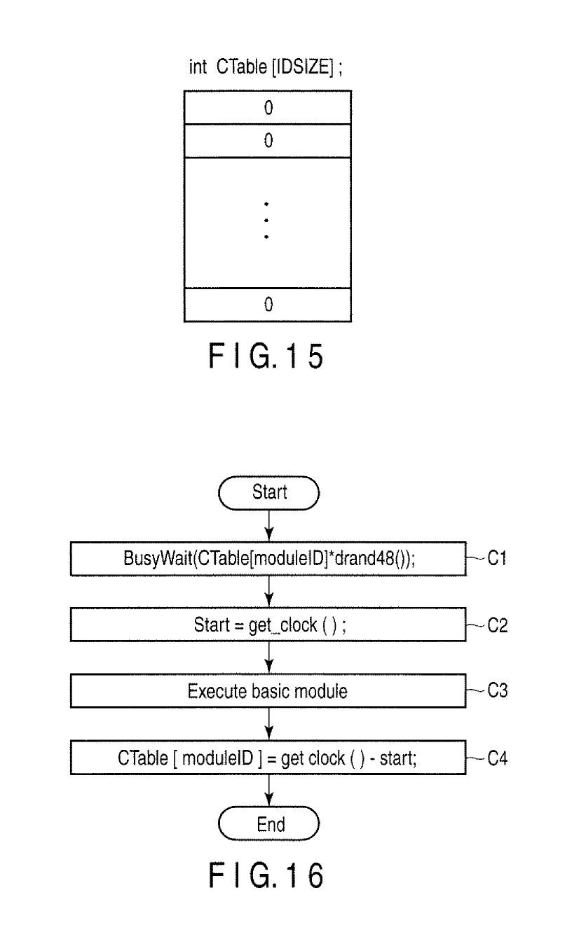

For example, the parallel process verification module 230 may include the function of managing such a table that holds, as shown in FIG. 15, the average processing time of the basic serial modules 101, and the function of inserting a random waiting time as shown in FIG. 16, thereby to delaying the timing of executing each basic serial module 101 (in an appropriate range deriving from the average processing time). Having these functions, the parallel process verification module 230 can determine where in the computer a timing problem, if any, has occurred.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a plurality of execution modules;
a system memory shared by the plurality of execution modules; and
a scheduler configured to control assignment of a plurality of basic modules to the plurality of execution modules based on a restriction of a execution sequence in order to execute a program in parallel by the plurality of execution modules, the program being divided into the plurality of basic modules executable asynchronously with other basic modules and being defined the restriction of a execution sequence for the plurality of basic modules,
the scheduler including a verification module configured to save data items, which is to be input by the execution modules as input data items of the basic modules and is stored in the storage areas of the system memory, in other storage areas of the system memory before the basic modules are executed, and to compare the data items stored in the storage areas of the system memory and accessed by the execution modules with the data items saved in the other storage areas of the system memory after the basic modules have been executed.

2. The information processing apparatus of claim 1, wherein the verification module of the scheduler is further configured to inform a warning when the data items, which have been input by the execution modules, stored in the storage areas of the system memory and the data items saved in the other storage area of the system memory differ from each other.

3. The information processing apparatus of claim 1, wherein the verification module of the scheduler is further configured to assign, when a first basic module is executed by a first execution module, a second basic module to a second execution module to execute the second basic module, the second basic module being identical to the first basic module and inputting the data items saved in the other storage areas of the system memory, and to compare the data items output from the first and second execution modules and stored in the storage areas of the system memory as output data items of the first and second basic modules after the first and second basic modules have been executed.

4. The information processing apparatus of claim 1, further comprising a setting module configured to set whether or not the verification module of the scheduler to be activated.

5. An information processing apparatus comprising:
a plurality of execution modules;
a system memory shared by the plurality of execution modules; and
a scheduler configured to control assignment of a plurality of basic modules to the plurality of execution modules based on a restriction of a execution sequence in order to execute a program in parallel by the plurality of execution modules, the program being divided into the plurality of basic modules executable asynchronously with other basic modules and being defined the restriction of a execution sequence for the plurality of basic modules,
the scheduler including a verification module configured to assign, when a first basic module is executed by a first executed modules a second basic module to a second execution module to execute the second basic module, the second basic module being identical to the first basic module and inputting the data items, which is to be input by the first execution module as input data items of the first basic modules, saved in the storage areas of the system memory, and to compare the data items output from the first and second execution modules and stored in the storage areas of the system memory as out put data items of the first and second basic modules after the first and second basic modules have been executed.

6. The information processing apparatus of claim 5, wherein the verification module of the scheduler is further configured to inform a warning when the data items, which are output from the first and second execution modules, stored in the storage areas of the system memory differ from each other.

7. The information processing apparatus of claim 5, further comprising a setting module configured to set whether or not the verification module of the scheduler to be activated.

8. An information processing apparatus comprising:
a plurality of execution modules; and
a scheduler configured to control assignment of a plurality of basic modules to the plurality of execution modules based on a restriction of a execution sequence in order to execute a program in parallel by the plurality of execution modules, the program being divided into the plurality of basic modules executable asynchronously with other basic modules and being defined the restriction of a execution sequence for the plurality of basic modules,
the scheduler including:
a measuring module configured to measure an average time of executing the basic modules in the respective execution modules; and
a verification module configured to calculate time period for which to delay the executing of the basic modules by using the average time measured by the measuring module before the basic modules are executed, and to delay the executing of the basic modules for the calculated time period.

9. A method of verifying a program for an information processing apparatus which includes a plurality of execution module; a system memory shared by the plurality of execution modules; and a scheduler configured to control assignment of a plurality of basic modules to the plurality of execution modules based on a restriction of a execution sequence in order to execute a program in parallel by the plurality of execution modules, the program being divided into the plurality of basic modules executable asynchronously with other basic modules and being defined the restriction of a execution sequence for the plurality of basic modules, the method comprising:
saving data items, which is to be input by the execution modules as input data items of the basic modules and is stored in the storage areas of the system memory in other storage areas of the system memory before the basic modules are executed; and
comparing the data items stored in the storage areas of the system memory and accessed by the execution modules with the data items saved in the other storage areas of the system memory after the basic modules have been executed.

10. A method of verifying a program for an information processing apparatus which includes a plurality of execution module; a system memory shared by the plurality of execution modules; and a scheduler configured to control assignment of a plurality of basic modules to the plurality of execution modules based on a restriction of a execution sequence in order to execute a program in parallel by the plurality of execution modules, the program being divided into the plurality of basic modules executable asynchronously with other basic modules and being defined the restriction of a execution sequence for the plurality of basic modules, the method comprising:
assigning, when a first basic module is executed by a first executed modules, a second basic module to a second execution module to execute the second basic module, the second basic module being identical to the first basic module and inputting the data items, which is to be input by the first execution module as input data items of the first basic modules, saved in the storage areas of the system memory; and
comparing the data items output from the first and second execution modules and stored in the storage areas of the system memory as output data items of the first and second basic modules after the first and second basic modules have been executed.

11. A method of verifying a program for an information processing apparatus which includes a plurality of execution module; and a scheduler configured to control assignment of a plurality of basic modules to the plurality of execution modules based on a restriction of a execution sequence in order to execute a program in parallel by the plurality of execution modules, the program being divided into the plurality of basic modules executable asynchronously with other basic modules and being defined the restriction of a execution sequence for the plurality of basic modules, the method comprising:
measuring an average time of executing the basic modules in the respective execution modules;
calculating time period for which to delay the executing of the basic modules by using the average time measured by the measuring module before the basic modules are executed; and
delaying the executing of the basic modules for the calculated time period.
